(19) United States
(12) Patent Application Publication
(10) Pub. No.: US 2024/0151940 A1
(43) Pub. Date: May 9, 2024

(54) LENS OPTICAL SYSTEM AND IMAGING APPARATUS USING THE SAME

(71) Applicant: SAMYANG OPTICS CO., LTD, Changwon-si (KR)

(72) Inventor: Juyeon JO, Changwon-si (KR)

(73) Assignee: SAMYANG OPTICS CO., LTD, Changwon-si (KR)

(21) Appl. No.: 18/049,484

(22) Filed: Oct. 25, 2022

(51) Int. Cl. G02B 9/64; G02B 7/04

(52) U.S. Cl. CPC G02B 9/64; G02B 7/04

(57) ABSTRACT

A lens optical system includes a first lens group having a positive refractive power, a second lens group consisting of two or less lenses and having a positive refractive power, and a third lens group having a negative refractive power. The second lens group is configured to perform a focusing operation to correct a change in an image distance dependent on a change in an object distance, and the first lens group and the third lens group are fixed and the overall length of the lens optical system does not change during the focusing operation.

### BACKGROUND

### 1. Technical Field

The present invention relates to a lens optical system for photographing and a photographing apparatus including the same, which guarantee high resolution with focusing two or less lenses in order to obtain a fast auto-focusing.

### 2. Description of the Related Art

Recently, miniaturization of photographing apparatuses, power saving functions, or the like have been required, and miniaturization of photographing devices using solid-state imaging devices such as CCD (charge-coupled devices) type image sensors or CMOS (complementary metal-oxide semiconductor) type image sensors have been required. Such photographing apparatuses include digital still cameras, video cameras, interchangeable lens cameras, or the like.

In addition, since the photographing apparatuses using the solid-state imaging devices are suitable for miniaturization, it is also applied to small information terminals such as mobile phones. Users have demands for high performance such as high resolution, a wide angle, or the like. In addition, as consumer expertise in cameras continues to increase, demand for short focal length lens systems such as wide-angle lens systems and telephoto lens systems is increasing.

In particular, a camera of the same type as a CSC (compact system camera) is a form that removes a pentaprism or a reflection mirror from tan existing DSLR (digital single lens reflex). Therefore, it has the benefit of being relatively small in volume and light, so it has good mobility and is easy to carry. However, in such a CSC, interchangeable lenses using a full-frame imaging device are required to obtain high-quality photographs. The larger the size of the imaging device, the larger the interchangeable lens and the larger the volume. When the interchangeable lens coupled to the CSC becomes heavy, it decreases portability and convenience. Therefore, even if a full-frame imaging device is used, it is necessary to reduce an overall length of a product to some extent. To this end, an inner type can be used, in which the overall length is fixed during the focusing operation.

Generally, it is necessary to move a particular lens group in the lens optical system in order to correct the change of imaging point according to the change of the object position. The conventional interchangeable lenses use various types for moving lens groups, such as a front type for moving a front lens group, a rear type for moving a rear lens group, an inner type for moving only an inner lens group, and a floating type for moving a plurality of lens groups.

In this regard, Japanese patent publication 2017-161849A discloses a rear type for moving a rear lens group that moves all lenses in the rear lens group while focusing. Accordingly, it is difficult to achieve fast speed while focusing due to heavy weight of the focusing lens group.

On the other hand, Japanese patent publication 2020-16755A discloses compensating using a single focusing lens the performance variation according to a change in an object distance, but there is a limit that it is hard to control the performance variation regarding both the infinite distance and a main photographing distance.

### SUMMARY

Aspects of the present invention provide a lens optical system for photographing, which has an inner type advantageous in achieving dust proof and water drop proof. The focusing lens group in the lens optical system may be comprised of two or less lenses in order to lighten the focusing lens group.

Aspects of the present invention also provide a lens optical system for photographing, which has a fast AF speed and is robust against the performance change according to a change in an object distance.

However, aspects of the present invention are not restricted to those set forth herein. The above and other aspects of the present invention will become more apparent to one of ordinary skill in the art to which the present invention pertains by referencing the detailed description of the present invention given below.

According to an aspect of an exemplary embodiment, there is provided a lens optical system, comprising a first lens group having a positive refractive power, a second lens group consisting of two or less lenses and having a positive refractive power, and a third lens group having a negative refractive power, wherein the second lens group is configured to perform a focusing operation to correct a change in an image distance dependent on a change in an object distance, wherein the first lens group and the third lens group are fixed and the overall length of the lens optical system does not change during the focusing operation, wherein one or more lens having a refractive power greater than 1.9 is disposed in the first lens group or the third lens group, and wherein the lens optical system satisfies the following equation:

$$0.29 \leq \frac{{f}_{Effective}}{{L}_{total}} \leq 0.39 ,$$

where the f_{Effective} is an effective focal length of the lens optical system and the Lₜₒₜₐₗ is the overall length of the lens optical system.

The lens optical system further satisfies the following equation:

Vd_{G-average}≤56.8,

where the Vd_{G-average} is an average of dispersion constants from lenses which have the highest dispersion constant in each lens group among the first to the third lens groups.

The lens optical system further satisfies the following equation:

$$- 0.44 \leq \frac{{L}_{S}}{{L}_{f}} \leq - 0.32 ,$$

where the Lₛ is a difference between positions of the first lens in the second lens group in an optical axis direction for the case where the object distance is infinite and for the case where the object distance is an MOD, and the L_{f} is a position of the first lens in the second lens group for the case where the object distance is infinite.

The lens optical system further satisfies the following equation:

$$0.54 \leq \frac{1}{{n}_{a}} \leq 0.63 ,$$

where the nₐ is a reciprocal of an average refractive index of all lenses used in the lens optical system.

The first lens facing the object side in the first lens group has a meniscus shape convex toward the object side, and the first lens facing the image side in the third lens group has a meniscus shape convex to the image side.

The second lens group includes at least one aspherical lens.

The first lens group or the third lens group includes at least one aspherical lens.

The first lens group or the third lens group includes at least one double-junction lens.

### BRIEF DESCRIPTION OF THE DRAWINGS

The above and other aspects and features of the present invention will become more apparent by describing in detail exemplary embodiments thereof with reference to the attached drawings, in which:

FIG. 1 is a view showing an optical layout showing an arrangement of lens components in a lens optical system according to a first embodiment of the present invention.

FIG. 2 is a view showing a ray fan diagram of the lens optical system at an infinite distance, according to the first embodiment of the present invention.

FIG. 3 is a view showing an optical layout showing an arrangement of lens components in a lens optical system according to a second embodiment of the present invention.

FIG. 4 is a view showing a ray fan diagram of the lens optical system at an infinite distance, according to the second embodiment of the present invention.

FIG. 5 is a view showing an optical layout showing an arrangement of lens components in a lens optical system according to a third embodiment of the present invention.

FIG. 6 is a view showing a ray fan diagram of the lens optical system at an infinite distance, according to the third embodiment of the present invention.

FIG. 7 is a view showing an optical layout showing an arrangement of lens components in a lens optical system according to a fourth embodiment of the present invention.

FIG. 8 is a view showing a ray fan diagram of the lens optical system at an infinite distance, according to the fourth embodiment of the present invention.

FIG. 9 shows a photographing apparatus having the lens optical system according to the embodiments of the present invention.

### DETAILED DESCRIPTION OF THE EMBODIMENTS

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

The present invention provides a lens optical system which has a high resolution and operates in a wide angle near 84° of FOV (field-of-view). A lens optical system having a short focal length generally adopts a wide angle FOV that is used for photographing landscapes or short-distance persons. In a camera using short focal length lenses, the image position focused in the image sensor changes according to the distance of the photographed object, which deteriorates the photographing quality without an additional compensation. To this end, it requires a focusing operation for correcting the imaging point while maintaining the optical performance with regard to various object distances including a long distance, a short distance and middle distance.

The present invention proposes fixing the overall length of the lens focal system by focusing with use of a single lens group in the lens focal system. As described above, in order to correct the change in the image position according to the distance of the photographed object, it is necessary to move a specific lens group in a camera. The conventional interchangeable lenses use various types for moving lens groups, such as a front type for moving a front lens group, a rear type for moving a rear lens group, an inner type for moving only an inner lens group, and a floating type for moving a plurality of lens groups at the same time.

The inner type is advantageous in achieving dust proof and water drop proof due to the fixing of the front lens group and the rear lens group. On the other hand, the floating type is advantageous in correcting aberrations since it moves two or more lens groups for correcting aberrations, but it requires complicated structures inside the camera and results in heavy weight.

In order to obtain proper focusing operations, a driving motor is used as a driving source that moves the plurality of lenses in the lens optical system. Since the heavy focusing lens group makes the AF speed slower, the present invention proposes adopting aspheric lenses in order to minimize the weight of the focusing lens group while satisfying a high resolution. Accordingly, various aberrations that deteriorates the photographing quality can be effectively controlled by using those aspheric lenses. Preferably, the surfaces to which the aspheric lenses are applied need to be the surfaces near the object side or those near the image sensor on which the image is focused in order to maximize correction effects. Here, it is not preferable to move the front lens group or the rear lens group to which the aspheric lenses are applied, because it makes larger effective diameters of the aspherical lenses and results in high manufacturing cost and heavy weight of the lens optical system.

Hereinafter, an embodiment of the present invention will be described in detail with reference to the accompanying drawings.

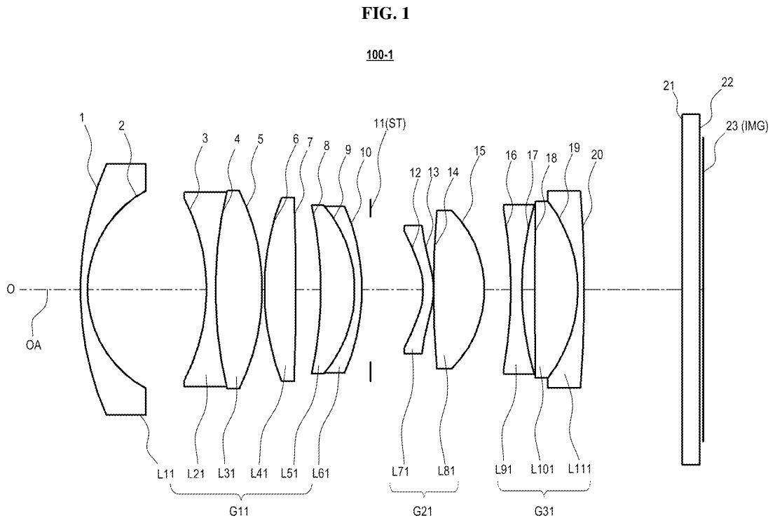

FIG. 1 is a view showing an optical layout showing an arrangement of lens components in a lens optical system according to a first embodiment of the present invention.

A lens optical system 100-1 includes a first lens group G11 having a positive refractive power, a second lens group G21 having a positive refractive power, and a third lens group G31 having a negative refractive power, which are arranged in order from an object side O to an image side I. In focusing, the first lens group G11 and the third lens group G31 are fixed to maintain a constant length of the overall length, and the second lens group G21 which is comprised of two lenses in the middle may be moved.

Hereinafter, the image side I may indicate a direction where an image plane IMG is positioned, in which an image is formed on the image plane IMG, and the object side O may indicate a direction in which a subject is positioned. In addition, the “object side” of a lens means, for example, the left side of the drawing toward a lens surface where the subject is positioned. The “back side of the image I” may indicate the right side of the drawing toward a lens surface where the image plane is positioned. The image plane IMG may be, for example, an imaging device surface or an image sensor surface. The image sensor may include, for example, a sensor such as a CMOS (complementary metal oxide semiconductor) image sensor or a CCD (charge coupled device). The image sensor is not limited thereto, and may be, for example, a device that converts an image of a subject into an electrical image signal.

In the lens optical system according to the first embodiment, the first lens group G11 may embody a wide angle by emitting light with a positive refractive power. In addition, an aperture ST may be arranged between the first lens group G11 and the second lens group G21.

When focusing from infinity to the nearest distance, the first lens group G11 and the third lens group G31 are fixed, the second lens group G21 may move independently and moves from the image side Ito the object side O. When the first lens group G11 and the third lens group G31 are fixed in focusing, damage or impairment to the lens due to the protrusion of the first lens group G11 may be reduced, and it may contribute to miniaturization of the lens optical system by preventing an increase in length of the overall length.

Meanwhile, an aspheric lens is preferably employed in the second lens group G21 so that the center resolution performance may be enhanced. The aspheric lens refers to a specific lens in which the radius of curvature changes according to the offset position from the center of the lens. In particular, the aspheric surface may be employed on both surfaces of the lens positioned on the object side O immediately behind the aperture ST. Alternatively, the aspheric lens may be employed in the first lens group G11 to minimize the change in the spherical aberration according to the focusing of the second lens group G21, or the aspheric lens may be employed in the third lens group G31 for a bright lens optical system which has a small F number Fno.

Referring to FIG. 1, the first lens group G11 may include a first lens L11 having a negative refractive power, a second lens L21 having a negative refractive power, a third lens L31 having a positive refractive power, a fourth lens L41 having a positive refraction power, a fifth lens L51 having a positive refraction power, and a sixth lens L61 having a negative refraction power. Among them, the second lens L21 and the third lens L31 may be double-junction lenses bonded to each other.

The first lens L11 may have a meniscus shape convex toward the object side O and the second lens L21 may be a biconcave lens. Further, the third lens L31 and the fourth lens L41 may be biconvex lenses and the fifth lens L51 and the sixth lens L61 may have meniscus shapes convex toward the image side I.

The second lens group G21 may be comprised of a seventh lens L71 having a negative refractive power and an eighth lens L81 having a positive refraction power. The seventh lens L71 may have a meniscus shape convex toward the image side I and the eighth lens L81 may be a biconvex lens. In particular, the seventh lens L71 may be an aspheric lens.

The third lens group G31 may include a ninth lens L91 having a negative refractive power, a tenth lens L101 having a positive refractive power, and an eleventh lens L111 having a negative refractive power. The ninth lens L91 may be a biconcave lens, the tenth lens L101 may be a biconvex lens, and the eleventh lens L111 may have a meniscus shape convex toward the image side I. In particular, the ninth lens L91 may be an aspheric lens.

The lens optical system according to the first embodiment has the following characteristic values as a whole by a combination of individual lenses. Here, f denotes a focal length, Fno denotes an F number, and HFOV denotes a half angle of view.

f=24.800 mm, Fno: 1.86, HFOV=41.87°

In addition, detailed design data of the lenses included in the lens optical system is shown in Table 1 below. The design data indicates information such as a curvature radius of a lens, a thickness of a lens, an interval between lenses, a material of a lens material, or the like. Here, an object on the lens surface is added with a number (see the numbering of 1 to 23 in FIG. 1) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 1

| Surface | Radius | Thickness | nd | vd | Note |
|---|---|---|---|---|---|
| Object | | D0 | | | |
| 1 | 45.456 | 1 | 1.6968 | 55.46 | Group 1 |
| 2 | 16.103 | 16.958 | | | (Fix) |
| 3 | −28.597 | 1.3 | 1.84666 | 23.78 | |
| 4 | 62.616 | 6.6 | 1.83481 | 42.72 | |
| 5 | −31.724 | 0.311 | | | |
| 6 | 35.374 | 4.48 | 2.001 | 29.13 | |
| 7 | −390.218 | 3.568 | | | |
| 8 | −55.477 | 4.81 | 1.497 | 81.61 | |
| 9 | −18.419 | 1 | 1.60342 | 38.01 | |
| 10 | −29.744 | 1.1 | | | |
| 11 | inf | D1 | | | |
| 12* | −9.326 | 1.4 | 1.68863 | 31.19 | Group 2 |
| 13* | −11.859 | 0.1 | | | (Focusing) |
| 14 | 185.016 | 7 | 1.59349 | 67 | |
| 15 | −16.395 | D2 | | | |
| 16* | −391.14 | 1.6 | 1.68863 | 31.19 | Group 3 |
| 17* | 28.633 | 1.771 | | | (Fix) |
| 18 | 916.855 | 6.13 | 1.497 | 81.61 | |
| 19 | −20.832 | 1 | 1.58144 | 40.89 | |
| 20 | −149.521 | 13.848 | | | |
| 21 | inf | 2.5 | 1.5168 | 64.2 | Filter |
| 22 | inf | 0.5 | | | |
| 23 | inf | 0 | | | |

In the first embodiment shown in FIG. 1, the seventh lens L71 having object numbers 12 and 13 and the ninth lens L91 having object numbers 16 and 17 are the aspheric lenses, respectively. When a direction of an optical axis OA is a z axis and a direction perpendicular to the direction of the optical axis direction is a y axis, the aspheric shape may be expressed by the following Equation 1 by making a direction of a light beam positive.

$$z = \frac{{cr}^{2}}{1 + \sqrt{1 - ( 1 + K ) {c}^{2} {r}^{2}}} + {Ar}^{4} + {Br}^{6} + {Cr}^{8} + {Dr}^{10} + {Er}^{12} \qquad [ Equation 1 ]$$

Here, Z denotes a distance from a vertex of the lens in the direction of the optical axis, r denotes a distance in the direction perpendicular to the optical axis OA, K denotes a conic constant, A, B, C, D, E, etc. denotes aspheric coefficients, and c represents a reciprocal of a radius of curvature 1/R at the vertex of the lens, respectively.

Data of specific aspheric coefficients having the surfaces of the aspheric lenses are shown in Table 2 below.

TABLE 2

| ASP | 12* | 13* | 16* | 17* |
|---|---|---|---|---|
| K | −2.3486810E+00 | −1.4469360E+00 | −1.0000000E+01 | −1.0315520E+00 |
| A | 1.2773409E−04 | 3.2842384E−04 | −9.2691251E−05 | −1.0271893E−04 |
| B | 5.0049330E−07 | −6.0327396E−07 | 4.4152933E−07 | 7.8806043E−07 |
| C | −3.2547623E−08 | −1.4526860E−08 | −4.0515264E−10 | −3.2185848E−09 |
| D | 2.9173457E−10 | 1.3703348E−10 | −4.8374620E−12 | 7.7624063E−12 |
| E | −1.0415829E−12 | −4.1052113E−13 | 1.3667864E−14 | −8.8352174E−15 |

Further, zoom data of the lens optical system according to the first embodiment is shown in Table 3 below, when the distance to the image side I is infinity in the first embodiment and when the magnification is −1/40 times and the distance TL is 0.19 m, Here, D0 to D2 denote a variable distance, and “in Air” denotes a distance from the last surface of the lens optical system to the imaging device when there is no filter positioned in front of the imaging device. In addition, FOV is a field of view, which means a size of an area visible to the imaging device, and Fno means an F number. In addition, OAL denotes an overall length of the lens optical system, that is, the distance from the object side to the image plane of the lens closest to the object side O of the lens optical system.

TABLE 3

| Config | Infinity | m = − 1/40 | TL = 0.19 m |
|---|---|---|---|
| D0 | Infinity | 915.554 | 101.451 |
| D1 | 10.562 | 10.155 | 7.642 |
| D2 | 1 | 1.407 | 3.92 |
| in Air | 15.994 | 15.994 | 15.994 |
| FOV | 83.74 | 84.55 | 86.07 |
| Fno | 1.86 | 1.85 | 2.04 |
| OAL | 71.69 | 71.69 | 71.69 |

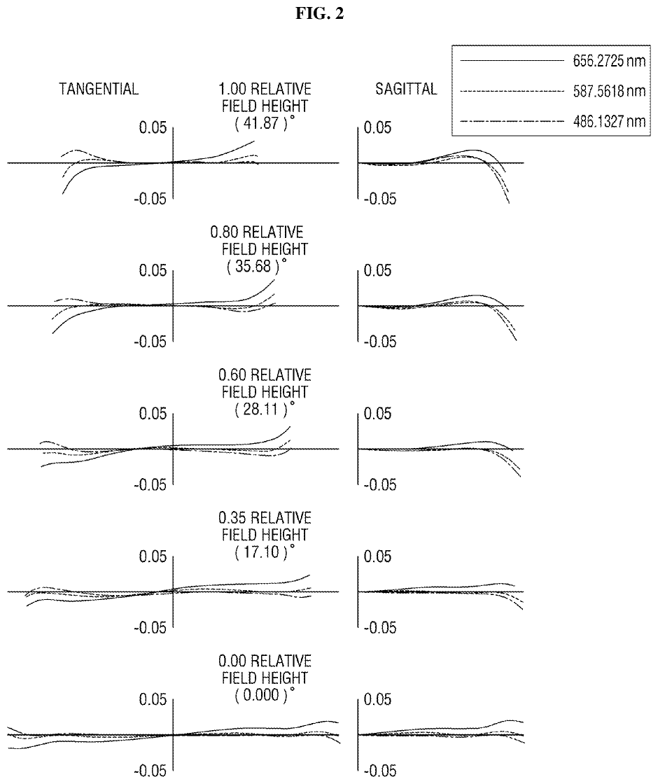

FIG. 2 is a view showing a ray fan diagram of the lens optical system at an infinite distance, according to the first embodiment of the present invention shown in FIG. 1. Here, a solid line denotes a 656.2725 nm wavelength (C-line), a dotted line denotes a 587.5618 nm wavelength (d-line), and a dashed line denotes a ray fan (unit: mm) for a 486.1327 nm wavelength (F-line).

These ray fans are plotted as a ray fan graph for the respective Tangential and Sagittal planes when the relative field heights are 0 F, 0.35 F, 0.60 F, 0.80 F and 1.00 F.

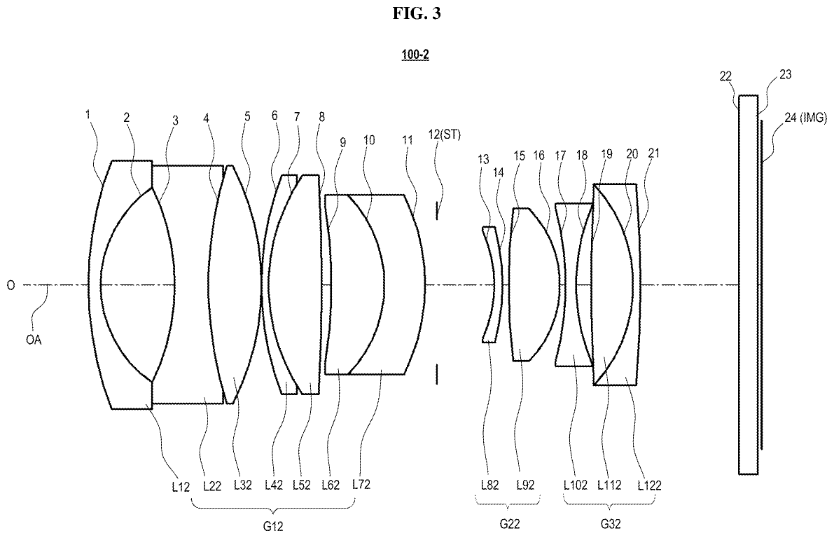

FIG. 3 is a view showing an optical layout showing an arrangement of lens components in a lens optical system according to a second embodiment of the present invention.

A lens optical system 100-2 includes a first lens group G12 having a positive refractive power, a second lens group G22 having a positive refractive power, and a third lens group G32 having a negative refractive power, which are arranged in order from an object side O to an image side I. In focusing, the first lens group G12 and the third lens group G32 are fixed to maintain a constant length of the overall length, and the second lens group G22 which is comprised of two lenses in the middle may be moved.

In the lens optical system according to the second embodiment, the first lens group G12 may embody a wide angle by emitting light with a positive refractive power. In addition, an aperture ST may be arranged between the first lens group G12 and the second lens group G22.

When focusing from infinity to the nearest distance, the first lens group G12 and the third lens group G32 are fixed, the second lens group G22 may move independently and moves from the image side I to the object side O. When the first lens group G12 and the third lens group G32 are fixed in focusing, damage or impairment to the lens due to the protrusion of the first lens group G11 may be reduced, and it may contribute to miniaturization of the lens optical system by preventing an increase in length of the overall length.

Meanwhile, an aspheric lens is preferably employed in the second lens group G22 so that the center resolution performance may be enhanced. In particular, the aspheric surface may be employed on both surfaces of the lens positioned on the object side O immediately behind the aperture ST.

Referring to FIG. 3, the first lens group G12 may include a first lens L12 having a negative refractive power, a second lens L22 having a negative refractive power, a third lens L32 having a positive refractive power, a fourth lens L42 having a negative refraction power, a fifth lens L52 having a positive refraction power, a sixth lens L62 having a positive refraction power, and a seventh lens L72 having a negative refraction power. Among them, the second lens L22 and the third lens L32, the fourth lens L42 and the fifth lens L52, and the sixth lens L62 and the seventh lens L72 may be double-junction lenses bonded to each other, respectively.

The first lens L12 may have a meniscus shape convex toward the object side O and the second lens L22 may be a biconcave lens. Further, the third lens L32 may be a biconvex lens and the fourth lens L42 may have a meniscus shape convex toward the object side O. In addition, the fifth lens L52 may be a biconvex lens, and the sixth lens L62 and the seventh lens L72 may have meniscus shapes convex toward the image side I.

The second lens group G22 may be comprised of an eighth lens L82 having a negative refractive power and a ninth lens L92 having a positive refraction power. The eighth lens L82 may have a meniscus shape convex toward the image side I and the ninth lens L92 may be a biconvex lens. In particular, the eighth lens L82 may be an aspheric lens.

The third lens group G32 may include a tenth lens L102 having a negative refractive power, an eleventh lens L112 having a positive refractive power, and a twelfth lens L122 having a negative refractive power. The tenth lens L102 may be a biconcave lens, the eleventh lens L112 may be a biconvex lens, and the twelfth lens L122 may have a meniscus shape convex toward the image side I. In particular, the eleventh lens L112 and the twelfth lens L122 may be aspheric lenses.

The lens optical system according to the second embodiment has the following characteristic values as a whole by a combination of individual lenses. Here, f denotes a focal length, Fno denotes an F number, and HFOV denotes a half angle of view.

f=23.512 mm, Fno: 1.86, HFOV=43.51°

In addition, detailed design data of the lenses included in the lens optical system is shown in Table 4 below. The design data indicates information such as a curvature radius of a lens, a thickness of a lens, an interval between lenses, a material of a lens material, or the like. Here, an object on the lens surface is added with a number (see the numbering of 1 to 24 in FIG. 3) indicating a surface of all lenses arranged from the object to the image. Among these 20 numbers, “*” indicates a surface of the aspheric lens. In addition, the unit of Radius and Thickness is mm, “nd” denotes a refractive index, and “vd” denotes an Abbe number.

TABLE 4

| Surface | Radius | Thickness | nd | vd | Note |
|---|---|---|---|---|---|
| Object | | D0 | | | |
| 1 | 47.835 | 1.8 | 1.92101 | 33.83 | Group 1 |
| 2 | 17.105 | 10.726 | | | (Fix) |
| 3 | −33.051 | 5 | 1.9331 | 21.75 | |
| 4 | 58.34 | 7.65 | 1.93337 | 32.95 | |
| 5 | −37.863 | 0.1 | | | |
| 6 | 45.226 | 1 | 1.63502 | 41.45 | |
| 7 | 28.302 | 7.7 | 2.001 | 29.13 | |
| 8 | −263.988 | 1.455 | | | |
| 9 | −68.974 | 7.7 | 1.497 | 81.61 | |
| 10 | −18.613 | 5.94 | 1.64148 | 32.9 | |
| 11 | −28.78 | 2.16 | | | |
| 12 | inf | D1 | | | |
| 13* | −13.172 | 1.14 | 1.87795 | 37.3 | Group 2 |
| 14* | −16.044 | 0.973 | | | (Focusing) |
| 15 | 112.806 | 7.34 | 1.59349 | 67 | |
| 16 | −16.071 | D2 | | | |
| 17 | −42.147 | 1.47 | 1.72007 | 26.56 | Group 3 |
| 18 | 29.786 | 2.282 | | | (Fix) |
| 19 | 274.05 | 6.06 | 1.83481 | 42.72 | |
| 20 | −21.992 | 1 | 1.67178 | 27.38 | |
| 21 | −201.202 | 14.677 | | | |
| 22 | inf | 2.5 | 1.5168 | 64.2 | Filter |
| 23 | inf | 0.5 | | | |
| 24 | inf | 0 | | | |

In the second embodiment shown in FIG. 3, the eighth lens L82 having object numbers 13 and 14 is an aspheric lens. Data of specific aspheric coefficients having the surfaces of the aspheric lens is shown in Table 5 below.

TABLE 5

| ASP | 13* | 14* |
|---|---|---|
| K | −9.5624300E−01 | −9.6813500E−01 |
| A | 1.8859031E−04 | 2.2175860E−04 |
| B | 1.5560619E−06 | 1.6926097E−06 |
| C | −4.6660741E−08 | −3.8404734E−08 |
| D | 3.3752236E−10 | 2.4731542E−10 |
| E | −9.9377100E−13 | −5.7322440E−13 |

Further, zoom data of the lens optical system according to the second embodiment is shown in Table 6 below, when the distance to the image side I is infinity in the second embodiment and when the magnification is −1/40 times and the distance TL is 0.19 m, Here, D0 to D2 denote a variable distance, and “in Air” denotes a distance from the last surface of the lens optical system to the imaging device when there is no filter positioned in front of the imaging device. In addition, FOV is a field of view, which means a size of an area visible to the imaging device, and Fno means an F number. In addition, OAL denotes an overall length of the lens optical system, that is, the distance from the object side to the image plane of the lens closest to the object side O of the lens optical system.

TABLE 6

| Config | Infinity | m = − 1/40 | TL = 0.19 m |
|---|---|---|---|
| D0 | Infinity | 916.554 | 95.015 |
| D1 | 7.925 | 7.633 | 5.635 |
| D2 | 0.9 | 1.192 | 3.19 |
| in Air | 16.826 | 16.826 | 16.826 |
| FOV | 87.014 | 87.2796 | 88.491 |
| Fno | 1.86 | 1.88 | 2.08 |
| OAL | 80.32 | 80.32 | 80.32 |

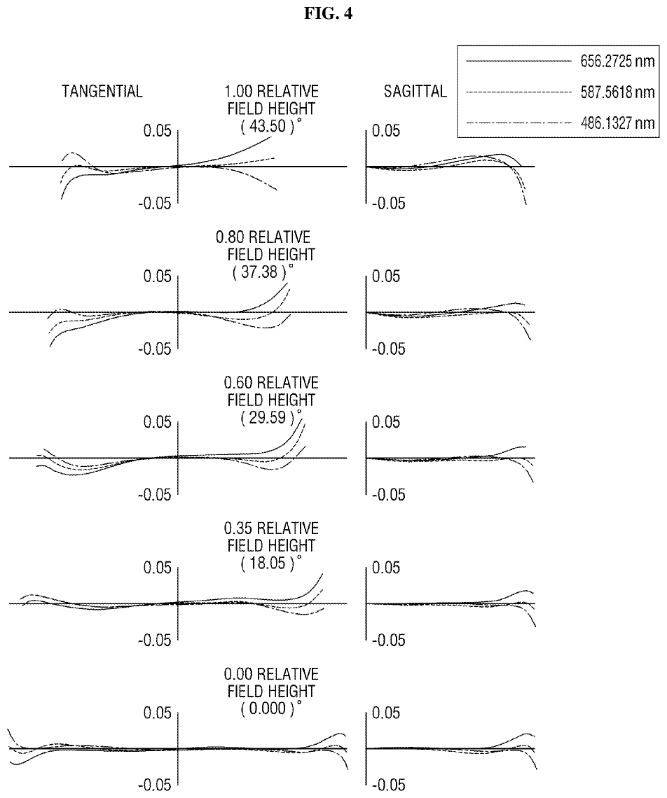

FIG. 4 is a view showing a ray fan diagram of the lens optical system at an infinite distance, according to the second embodiment of the present invention shown in FIG. 3. Here, a solid line denotes a 656.2725 nm wavelength (C-line), a dotted line denotes a 587.5618 nm wavelength (d-line), and a dashed line denotes a ray fan (unit: mm) for a 486.1327 nm wavelength (F-line).

These ray fans are plotted as a ray fan graph for the respective Tangential and Sagittal planes when the relative field heights are 0 F, 0.35 F, 0.60 F, 0.80 F and 1.00 F.

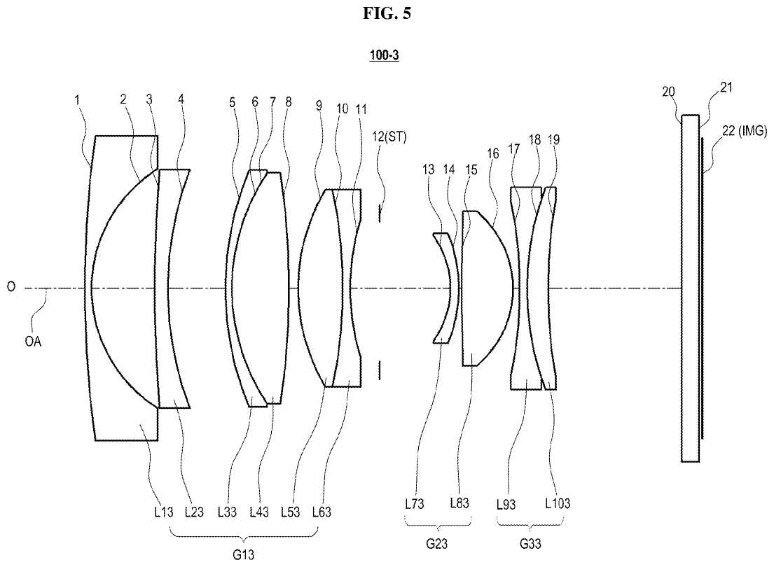

FIG. 5 is a view showing an optical layout showing an arrangement of lens components in a lens optical system according to a third embodiment of the present invention.

A lens optical system 100-3 includes a first lens group G13 having a positive refractive power, a second lens group G23 having a positive refractive power, and a third lens group G33 having a negative refractive power, which are arranged in order from an object side O to an image side I. In focusing, the first lens group G13 and the third lens group G33 are fixed to maintain a constant length of the overall length, and the second lens group G23 which is comprised of two lenses in the middle may be moved.

In the lens optical system according to the third embodiment, the first lens group G13 may embody a wide angle by emitting light with a positive refractive power. In addition, an aperture ST may be arranged between the first lens group G13 and the second lens group G23.

When focusing from infinity to the nearest distance, the first lens group G13 and the third lens group G33 are fixed, the second lens group G23 may move independently and moves from the image side Ito the object side O. When the first lens group G13 and the third lens group G33 are fixed in focusing, damage or impairment to the lens due to the protrusion of the first lens group G13 may be reduced, and it may contribute to miniaturization of the lens optical system by preventing an increase in length of the overall length.

Meanwhile, an aspheric lens is preferably employed in the second lens group G23 so that the center resolution performance may be enhanced. In particular, the aspheric surface may be employed on both surfaces of the lens positioned on the object side O immediately behind the aperture ST. Additionally, the aspheric lens may be employed in the first lens group G13 to minimize the change in the spherical aberration according to the focusing of the second lens group G23.

Referring to FIG. 5, the first lens group G13 may include a first lens L13 having a negative refractive power, a second lens L23 having a negative refractive power, a third lens L33 having a negative refractive power, a fourth lens L43 having a positive refraction power, a fifth lens L53 having a positive refraction power, and a sixth lens L63 having a negative refraction power.

The first lens L13, the second lens L23 and the third lens L33 may have a meniscus shape convex toward the object side O. Further, the fourth lens L43 and the fifth lens L53 may be biconvex lenses and the sixth lens L63 may be a biconcave lens. In particular, the second lens L23 may be an aspheric lens, and the fifth lens L53 and the sixth lens L63 may be double-junction lenses bonded to each other.

The second lens group G23 may be comprised of a seventh lens L73 having a negative refractive power and an eighth lens L83 having a positive refraction power. The seventh lens L73 may have a meniscus shape convex toward the image side I and the eighth lens L83 may be a biconvex lens. In particular, the seventh lens L73 may be an aspheric lens.

The third lens group G33 may include a ninth lens L93 having a negative refractive power and a tenth lens L103 having a positive refractive power. The ninth lens L93 may be a biconcave lens, and the tenth lens L103 may have a meniscus shape convex toward the object side O. In particular, the ninth lens L93 and the tenth lens L103 may be double-junction lenses bonded to each other.

The lens optical system according to the third embodiment has the following characteristic values as a whole by a combination of individual lenses. Here, f denotes a focal length, Fno denotes an F number, and HFOV denotes a half angle of view.

f=23.814 mm, Fno: 1.85, HFOV=42.53°

In addition, detailed design data of the lenses included in the lens optical system is shown in Table 7 below. The design data indicates information such as a curvature radius of a lens, a thickness of a lens, an interval between lenses, a material of a lens material, or the like. Here, an object on the lens surface is added with a number (see the numbering of 1 to 22 in FIG. 5) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 7

| Surface | Radius | Thickness | nd | vd | Note |
|---|---|---|---|---|---|
| Object | | D0 | | | |
| 1 | 154.475 | 1 | 1.63427 | 55.57 | Group 1 |
| 2 | 19.862 | 8.709 | | | (Fix) |
| 3* | 426.588 | 1.8 | 1.51453 | 63.1 | |
| 4* | 42.387 | 8.01 | | | |
| 5 | 42.539 | 1 | 1.54746 | 47.06 | |
| 6 | 29.506 | 0 | | | |
| 7 | 29.901 | 7.82 | 1.8042 | 46.5 | |
| 8 | −115.918 | 1.32 | | | |
| 9 | 27.331 | 6.25 | 1.8042 | 46.5 | |
| 10 | −64.071 | 1 | 1.68739 | 25.45 | |
| 11 | 34.18 | 8.266 | | | |
| 12 | inf | D1 | | | |
| 13* | −9.113 | 1.2 | 1.8054 | 40.66 | Group 2 |
| 14* | −11.036 | 0.389 | | | (Focusing) |
| 15 | 397.596 | 7.08 | 1.59349 | 67 | |
| 16 | −14.284 | D2 | | | |
| 17 | −62.454 | 1 | 1.65067 | 28.32 | Group 3 |
| 18 | 40.976 | 2.98 | 1.74397 | 44.85 | (Fix) |
| 19 | 81.382 | 18.539 | | | |
| 20 | inf | 2.5 | 1.5168 | 64.2 | Filter |
| 21 | inf | 0.5 | | | |
| 22 | inf | 0 | | | |

In the third embodiment shown in FIG. 5, the eighth lens L23 having object numbers 3 and 4, and the seventh lens L73 having object numbers 13 and 14 are aspheric lenses. Data of specific aspheric coefficients having the surfaces of the aspheric lens is shown in Table 8 below.

TABLE 8

| ASP | 3* | 4* | 13* | 14* |
|---|---|---|---|---|
| K | 9.7891600E−01 | 1.3719600E−01 | −1.0000000E+00 | −1.0000000E+00 |
| A | 1.9917665E−05 | 1.6204808E−05 | 1.4822743E−04 | 2.1411275E−04 |
| B | −1.1508117E−07 | −1.3062759E−07 | 6.0733227E−06 | 4.8868508E−06 |
| C | 3.3010152E−10 | 3.2955738E−10 | −1.1345304E−07 | −6.7241533E−08 |
| D | −5.1481069E−13 | −4.5865975E−13 | 6.7605712E−10 | 2.2732214E−10 |
| E | 2.4873656E−16 | 4.1685375E−18 | −1.5355153E−12 | 2.9962108E−13 |

Further, zoom data of the lens optical system according to the third embodiment is shown in Table 9 below, when the distance to the image side I is infinity in the third embodiment and when the magnification is −1/40 times and the distance TL is 0.22m, Here, D0 to D2 denote a variable distance, and “in Air” denotes a distance from the last surface of the lens optical system to the imaging device when there is no filter positioned in front of the imaging device. In addition, FOV is a field of view, which means a size of an area visible to the imaging device, and Fno means an F number. In addition, OAL denotes an overall length of the lens optical system, that is, the distance from the object side to the image plane of the lens closest to the object side O of the lens optical system.

TABLE 9

| Config | Infinity | m = − 1/40 | TL = 0.22 m |
|---|---|---|---|
| D0 | Infinity | 948 | 136 |
| D1 | 5.636 | 5.255 | 3.364 |
| D2 | 1 | 1.38 | 3.272 |
| in Air | 20.687 | 20.687 | 20.687 |
| FOV | 85.068 | 85.221 | 85.2938 |
| Fno | 1.85 | 1.85 | 1.95 |
| OAL | 64.46 | 64.46 | 64.46 |

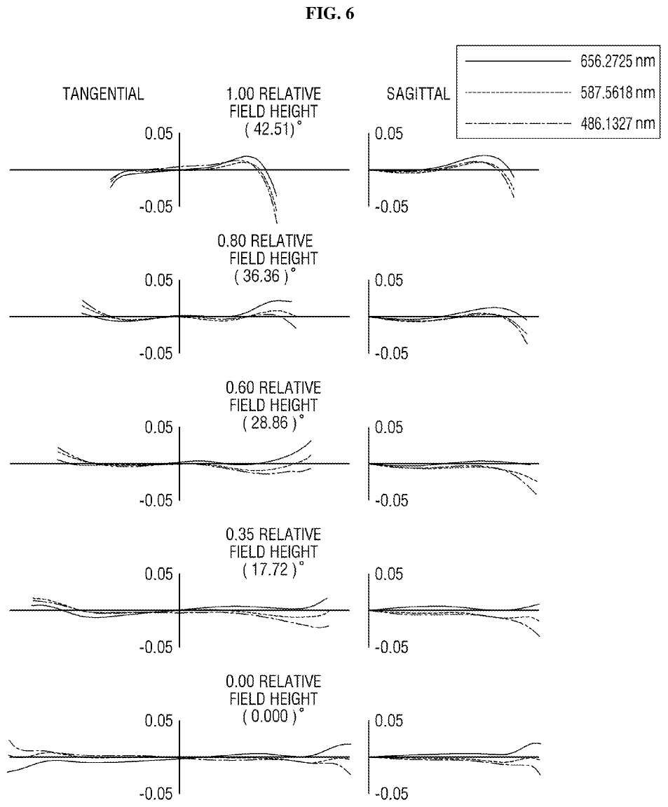

FIG. 6 is a view showing a ray fan diagram of the lens optical system at an infinite distance, according to the third embodiment of the present invention shown in FIG. 5. Here, a solid line denotes a 656.2725 nm wavelength (C-line), a dotted line denotes a 587.5618 nm wavelength (d-line), and a dashed line denotes a ray fan (unit: mm) for a 486.1327 nm wavelength (F-line).

These ray fans are plotted as a ray fan graph for the respective Tangential and Sagittal planes when the relative field heights are 0 F, 0.35 F, 0.60 F, 0.80 F and 1.00 F.

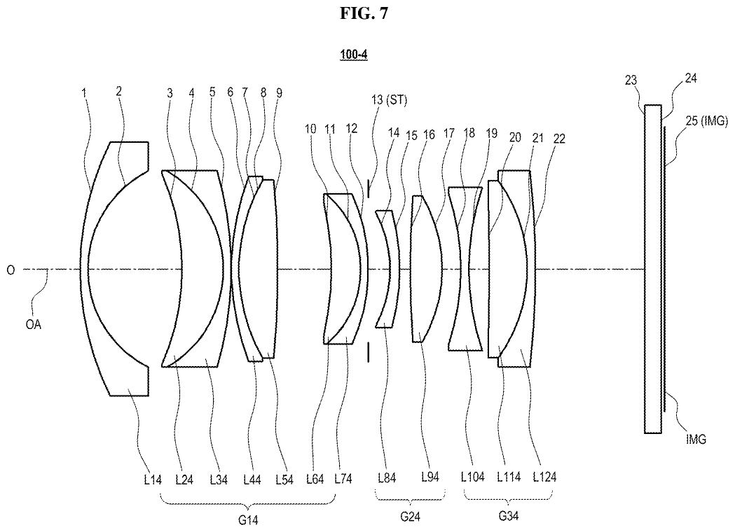

FIG. 7 is a view showing an optical layout showing an arrangement of lens components in a lens optical system according to a fourth embodiment of the present invention.

A lens optical system 100-4 includes a first lens group G14 having a positive refractive power, a second lens group G24 having a positive refractive power, and a third lens group G34 having a negative refractive power, which are arranged in order from an object side O to an image side I. In focusing, the first lens group G14 and the third lens group G34 are fixed to maintain a constant length of the overall length, and the second lens group G24 which is comprised of two lenses in the middle may be moved.

In the lens optical system according to the fourth embodiment, the first lens group G14 may embody a wide angle by emitting light with a positive refractive power. In addition, an aperture ST may be arranged between the first lens group G14 and the second lens group G24.

When focusing from infinity to the nearest distance, the first lens group G14 and the third lens group G34 are fixed, the second lens group G24 may move independently and moves from the image side I to the object side O. When the first lens group G14 and the third lens group G34 are fixed in focusing, damage or impairment to the lens due to the protrusion of the first lens group G14 may be reduced, and it may contribute to miniaturization of the lens optical system by preventing an increase in length of the overall length.

Meanwhile, an aspheric lens is preferably employed in the second lens group G24 so that the center resolution performance may be enhanced. In particular, the aspheric surface may be employed on both surfaces of the lens positioned on the object side O immediately behind the aperture ST.

Referring to FIG. 7, the first lens group G14 may include a first lens L14 having a negative refractive power, a second lens L24 having a positive refractive power, a third lens L34 having a negative refractive power, a fourth lens L44 having a negative refraction power, a fifth lens L54 having a positive refraction power, a sixth lens L64 having a positive refraction power, and a seventh lens L74 having a negative refraction power. Among them, the second lens L24 and the third lens L34, and the sixth lens L64 and the seventh lens L74 may be double-junction lenses bonded to each other, respectively.

The first lens L14 may have a meniscus shape convex toward the object side O, and the second lens L24 and the third lens L34 may have meniscus shapes convex toward the image side I. Further, the fourth lens L44 may have a meniscus shape convex toward the object side O, and the fifth lens L54 may be a biconvex lens. In addition, the sixth lens L64 and the seventh lens L74 may have meniscus shapes convex toward the image side I.

The second lens group G24 may be comprised of an eighth lens L84 having a negative refractive power and a ninth lens L94 having a positive refraction power. The eighth lens L84 may have a meniscus shape convex toward the image side I and the ninth lens L94 may be a biconvex lens. In particular, the eighth lens L84 may be an aspheric lens.

The third lens group G34 may include a tenth lens L104 having a negative refractive power, an eleventh lens L114 having a positive refractive power, and a twelfth lens L124 having a negative refractive power. The tenth lens L104 may be a biconcave lens, the eleventh lens L114 and twelfth lens 124 may have meniscus shapes convex toward the image side I. In particular, the eleventh lens L114 and the twelfth lens L124 may be double-junction lenses bonded to each other.

The lens optical system according to the fourth embodiment has the following characteristic values as a whole by a combination of individual lenses. Here, f denotes a focal length, Fno denotes an F number, and HFOV denotes a half angle of view.

f=24.410 mm, Fno: 1.86, HFOV=42.30°

In addition, detailed design data of the lenses included in the lens optical system is shown in Table 10 below. The design data indicates information such as a curvature radius of a lens, a thickness of a lens, an interval between lenses, a material of a lens material, or the like. Here, an object on the lens surface is added with a number (see the numbering of 1 to 25 in FIG. 7) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 10

| Surface | Radius | Thickness | nd | vd | Note |
|---|---|---|---|---|---|
| Object | | D0 | | | |
| 1 | 38.596 | 1 | 1.63854 | 55.45 | Group 1 |
| 2 | 15.197 | 12.904 | | | (Fix) |
| 3 | −32.801 | 5.63 | 1.64633 | 59.68 | |
| 4 | −15.454 | 1 | 1.64838 | 29.13 | |
| 5 | −49.366 | 0.1 | | | |
| 6 | 35.261 | 1 | 1.75095 | 22.09 | |
| 7 | 24.474 | 0.1 | | | |
| 8 | 24.559 | 5.22 | 2.001 | 29.13 | |
| 9 | −120.149 | 7.303 | | | |
| 10 | −42.023 | 4.03 | 1.77171 | 48.34 | |
| 11 | −13.239 | 1 | 1.9092 | 26.3 | |
| 12 | −24.215 | 0.1 | | | |
| 13 | inf | D1 | | | |
| 14* | −11.824 | 1.2 | 1.87795 | 37.3 | Group 2 |
| 15* | −16.108 | 1.466 | | | (Focusing) |
| 16 | 128.952 | 4.4 | 1.8042 | 46.5 | |
| 17 | −19.62 | D2 | | | |
| 18 | −32.928 | 1 | 1.60968 | 33.01 | Group 3 |
| 19 | 33.007 | 2.867 | | | (Fix) |
| 20 | −410.232 | 5.25 | 1.8042 | 46.5 | |
| 21 | −20.313 | 1 | 1.645 | 34.02 | |
| 22 | −133.803 | 14.976 | | | |
| 23 | inf | 2.5 | 1.5168 | 64.2 | Filter |
| 24 | inf | 0.5 | | | |
| 25 | inf | 0 | | | |

In the fourth embodiment shown in FIG. 7, the eighth lens L84 having object numbers 14 and 15 is an aspheric lens. Data of specific aspheric coefficients having the surfaces of the aspheric lens is shown in Table 11 below.

TABLE 11

| ASP | 14* | 15* |
|---|---|---|
| K | −1 | −1 |
| A | 2.4239860E−04 | 2.7208311E−04 |
| B | −9.3580692E−07 | −5.8828265E−07 |
| C | −4.1500724E−09 | −3.7021284E−09 |
| D | −1.5043934E−11 | −8.2345748E−12 |
| E | 4.3586604E−13 | 2.8008631E−13 |

Further, zoom data of the lens optical system according to the fourth embodiment is shown in Table 12 below, when the distance to the image side I is infinity in the fourth embodiment and when the magnification is −1/40 times and the distance TL is 0.24 m, Here, D0 to D2 denote a variable distance, and “in Air” denotes a distance from the last surface of the lens optical system to the imaging device when there is no filter positioned in front of the imaging device. In addition, FOV is a field of view, which means a size of an area visible to the imaging device, and Fno means an F number. In addition, OAL denotes an overall length of the lens optical system, that is, the distance from the object side to the image plane of the lens closest to the object side O of the lens optical system.

TABLE 12

| Config | Infinity | m = − 1/40 | TL = 0.24 m |
|---|---|---|---|
| D0 | Infinity | 916.55414 | 160.4606 |
| D1 | 4.658 | 4.3106768 | 2.9366685 |
| D2 | 0.8 | 1.1473232 | 2.5223315 |
| in Air | 17.124 | 17.124 | 17.124 |
| FOV | 84.615 | 84.7988 | 85.0852 |
| Fno | 1.86 | 1.86 | 1.95 |
| OAL | 62.03 | 62.03 | 62.03 |

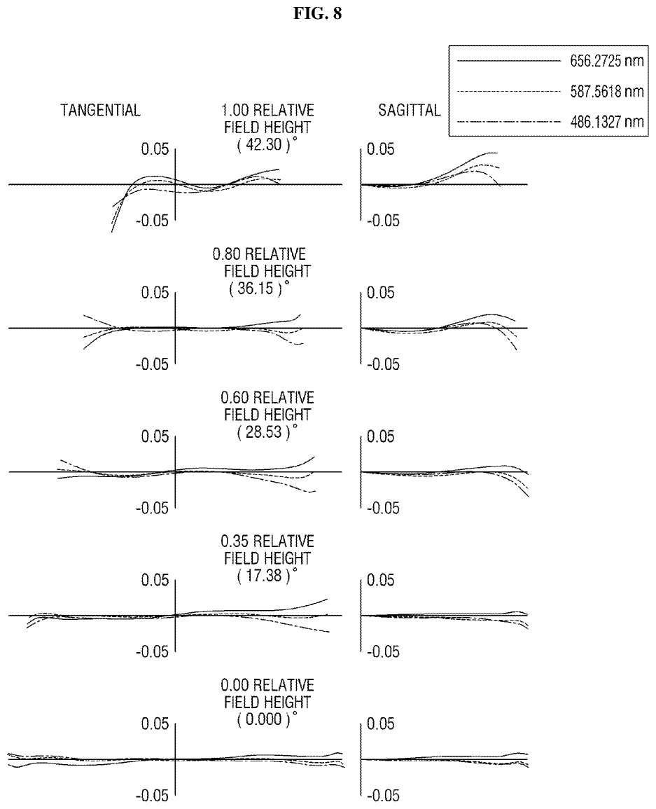

FIG. 8 is a view showing a ray fan diagram of the lens optical system at an infinite distance, according to the fourth embodiment of the present invention shown in FIG. 7. Here, a solid line denotes a 656.2725 nm wavelength (C-line), a dotted line denotes a 587.5618 nm wavelength (d-line), and a dashed line denotes a ray fan (unit: mm) for a 486.1327 nm wavelength (F-line).

These ray fans are plotted as a ray fan graph for the respective Tangential and Sagittal planes when the relative field heights are 0 F, 0.35 F, 0.60 F, 0.80 F and 1.00 F.

In the above four embodiments, indicators representing the respective optical characteristics are summarized in Table 13 below. Here, f_{Effective} is an effective focal length of the lens optical system and Lₜₒₜₐₗ is the overall length of the lens optical system.

In addition, Vd_{G-average} is an average of dispersion constants from lenses which have the highest dispersion constant in each lens group, and Lₛ is a difference between positions of the first lens in the focusing lens group in a direction of an optical axis for the case where the object distance is infinite and for the case where the object distance is an MOD (minimum of distance).

Further, L_{f} is the position of the first lens in the focusing lens group for the case where the object distance is infinite, and nₐ is a reciprocal of an average refractive index of all lenses used in the lens optical system.

TABLE 13

| | first | second | third | fourth |
|---|---|---|---|---|
| | embodi- | embodi- | embodi- | embodi- |
| | ment | ment | ment | ment |
| f_{Effective} | 24.8004 | 23.4990 | 23.8000 | 24.4000 |
| Lₜₒₜₐₗ | 71.6900 | 80.3227 | 64.4621 | 62.0254 |
| V_{d}_{_{G-average}} | 76.7400 | 70.9367 | 64.7667 | 56.7933 |
| Lₛ | −2.9198 | −2.2902 | −2.2932 | −1.7490 |
| L_{f} | 10.5620 | 7.9252 | 5.6357 | 4.6577 |
| nₐ | 1.6844 | 1.7717 | 1.6786 | 1.7693 |
| $0.29 \leq \frac{{f}_{Effective}}{{L}_{total}} \leq 0.39$ | 0.3459 | 0.2926 | 0.3692 | 0.3934 |
| Vd_{G-average} ≥ 56.8 | 76.7400 | 70.9367 | 64.7667 | 56.7933 |
| $- 0.44 \leq \frac{{L}_{S}}{{L}_{f}} \leq - 0.32$ | −0.2764 | −0.2890 | −0.4069 | −0.3755 |
| $0.54 \leq \frac{1}{{n}_{a}} \leq 0.63$ | 0.5937 | 0.5644 | 0.5957 | 0.5652 |

As described in various embodiments above, the lens optical system according to the present invention is a lens system for photographing with stable resolution operating in a wide-angle area. It is characterized that since it is a short focus optical system, focusing is required to correct a position of an image point that changes depending on a position of a subject. Here, the overall length of the lens optical system is fixed using the inner focusing in order to shorten the length of the overall length of the lens optical system, and it has a focusing lens group that is lightweight to realize high-speed auto-focusing (AF).

The first lens group mentioned in the above embodiments is from the first surface to an aperture surface ST, and its combined focal length has a positive refractive power. In this case, the apertures of the lenses included in the second lens group positioned after the first lens group may be reduced, which is advantageous for the high-speed AF. Since it is possible to reduce the weight of the moving lens group by configuring the lens group used for such AF in two or less and fixing the first and third lens groups in focusing, it contributes to achieve the high-speed AF.

It is advantageous to adopt the lightweight lenses in the focusing lens group in order to obtain a fast AF and accordingly, the lightweight lens material is preferably used for the lenses in the focusing lens group. However, since high refractive lenses cannot be adopted in the focusing lens group due to the lightweight condition, they need to be adopted in the first lens group or the third lens group.

Meanwhile, according to the various embodiment, it is possible to determine the overall length of the lens optical system for a specific FOV as defined in Equation 2.

$$0.29 \leq \frac{{f}_{Effective}}{{L}_{total}} \leq 0.39 \qquad [ Equation 2 ]$$

Each lens optical system according to the embodiments of the present invention has a shortened overall length since the first and the third lens groups are fixed even in focusing operation. In addition, it is possible to shorten more the overall length by adopting one or more aspheric lenses. Here, the lower limit of Equation 2 refers to a condition for reducing the overall length of the lens optical system for a specific FOV. If the ratio in Equation 2 is smaller than the lower limit, the size of the lens optical system gets larger to deteriorate its product competitiveness.

On the other hand, the upper limit of Equation 2 refers to secure the minimum overall length of the lens optical system for a specific FOV. If the ratio in Equation 2 is greater than the upper limit, the size of the lens optical system gets smaller but there may be a problem in the product performance or an increase in production cost caused by adopting additional lenes such as aspheric lenses to compensate the product performance.

Meanwhile, chromatic aberration may occur due to the difference between refractive powers from light wavelengths of the lenses in the lens optical system. However, the chromatic aberration may be compensated based on proper combination of refractive powers and dispersion constants in the overall lens optical system.

In order to reduce this chromatic aberration, the following Equation 3 may be applied.

Vd_{G-average}≤56.8 [Equation 3]

In lens optical systems according to the embodiments of the present invention, one or more low dispersive lens may be adopted for each lens group in order to control the overall chromatic aberration by reducing the chromatic aberration that occurs in each lens group. The above Equation 3 refers to an average of dispersion constants from low dispersive lenses in each lens group and the lower limit in Equation 3 is a condition for reducing the chromatic aberration that occurs in each lens group.

Meanwhile, the following Equation 4 refers to a condition for securing a fast AF and a shortened lens optical system, which limits time required for an AF directed to an object within ranges from the farthest distance allowed in the lens optical system to the closest distance with regard to the image sensor. It is possible to reduce the time required for the AF by directly limit the focusing movement, when an aberration according to focusing movement is relatively large and it is difficult to lighten lenses in the focusing lens group.

$$- 0.44 \leq \frac{{L}_{S}}{{L}_{f}} \leq - 0.32 \qquad [ Equation 4 ]$$

The above Equation 4 is a condition for limiting the overall length of the lens optical system having a proper sensitiveness of the focusing operation. If the ratio in Equation 4 is smaller than the lower limit, the overall length of the lens optical system gets longer to be a hindrance to a lightened lens optical system, which makes the overall AF time longer or AF speed slower due to a larger focusing travel.

As described above, we need to limit the focusing travel for the shortened lens optical system, but it related to a degree of freedom in selecting a driving source for the focusing. The above Equation 4 is a condition for securing sufficiently the overall travel for the focusing. That is, there may be a problem that the accuracy of focusing decreases due to a strict accuracy required for the driving source, on the condition that the ratio in Equation 4 is greater than the upper limit and thus the focusing travel gets too small.

Meanwhile, the following Equation 5 presents a condition for limiting Petzval curvature in image field of each lens in the lens optical system.

$$0.54 \leq \frac{1}{{n}_{a}} \leq 0.63 \qquad [ Equation 5 ]$$

In Equation 5, nₐ is a reciprocal of an average refractive index of all lenses used in the lens optical system. As the refractive index gets larger, the Petzval curvature in image field gets smaller. However, to use only lenses having high refractive indices causes high manufacturing cost, and to use a lot of lenses having low refractive indices considering the manufacturing cost increases aberrations from Petzval curvature in image field. Accordingly, the upper limit and the lower limit are conditions for effectively limiting Petzval curvature in image field and the amount of lens materials used in the lens optical system at the same time.

Generally, in a wide-angled lens optical system, the surface of the first lens facing the object side O is convex toward to the object side O in order to receive wide ranges of light. To this end, the surface of the first lens facing the image side I has a smaller curvature than the other surface of the first lens facing the object side O in order to satisfy an offence against sign condition (OSC), and thus, the first lens may be a meniscus lens convex toward to the object side O.

Meanwhile, each lens surface constituting a lens optical system basically has a certain reflexibility, which often deteriorates the photographing quality due to a flare phenomenon that makes unnecessary images caused by the overlap of light reflected on the lens surfaces. Generally, the cover glass for protecting the imaging device has a high reflexibility, and thus the flare phenomenon may happen if the lens closest to the imaging device, that is, the last lens in the lens optical system is flat or concave. Accordingly, it is possible to reduce the flare phenomenon by forming the last lens closest to the image side Ito be convex in order to disperse light reflected on the cover glass.

As described above, the present invention intends to shorten the overall length of the lens optical system while consistently correcting the performance change according to the object position. In this regard, two or more aspherical lenses may be used preferably for the focusing lens group in order to limit aberrations due to shortening the lens optical system. However, these aspheric lenses may make higher the manufacturing cost since sizes of aspheric lenses should be larger as they are closer to the first surface (object side O) or the last surface (image side I) in the lens optical system. To this end, in order to enhance the effect in correcting astigmatism and aberrations due to aspherical shape, it is preferable to adopt aspherical lenses for the second lens from the object side O or the other second lens from the image side I. In addition, it is preferable to dispose additional aspherical lenses closest to the aperture ST in order to be advantageous in correcting spherical aberrations and chromatic aberrations.

Further, in the above embodiments of the present invention, the first lens group and the third lens group may include one or more double junction lenses bonded to each other in order to guarantee a proper image focusing of the first and the third lens group and minimize the overall chromatic aberrations in the lens optical system.

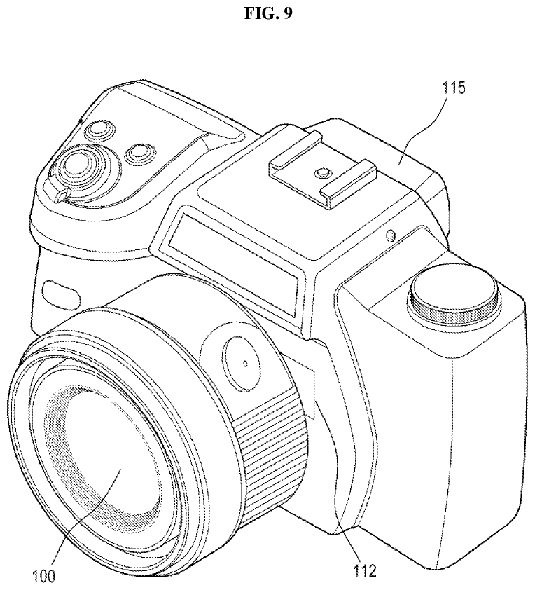

FIG. 9 shows a photographing apparatus having the lens optical system 100 according to the embodiments of the present invention. The lens optical system 100 is substantially the same as the lens systems 100-1, 100-2, 100-3, and 100-4 described with reference to FIGS. 1, 3, 5 and 7. The photographing apparatus may include an image sensor 112 that receives light formed by the lens optical system 100. Additionally, it may be provided with a display 115 on which an image of a subject is displayed.

According to the lens optical system described above, it is possible to maintain the overall length of the lens optical system by moving two or less lenses inside the lens optical system and this feature contributes to enhancing user's convenience and robustness to circumstances such as dustproof and waterproof.

In addition, it is unnecessary to use special lenses for enhancing performance since it effectively limits the performance change according to the object distance and maintains a fast AF speed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A lens optical system comprising a first lens group having a positive refractive power, a second lens group consisting of two or less lenses and having a positive refractive power, and a third lens group having a negative refractive power,
wherein the second lens group is configured to perform a focusing operation to correct a change in an image distance dependent on a change in an object distance,
wherein the first lens group and the third lens group are fixed and the overall length of the lens optical system does not change during the focusing operation,
wherein one or more lens having a refractive power greater than 1.9 is disposed in the first lens group or the third lens group, and
wherein the lens optical system satisfies the following equation:
$$0.29 \leq \frac{{f}_{Effective}}{{L}_{total}} \leq 0.39 ,$$
where the f_{Effective} is an effective focal length of the lens optical system and the Lₜₒₜₐₗ is the overall length of the lens optical system.

2. The system of claim 1, wherein the lens optical system further satisfies the following equation:
Vd_{G-average}56.8,
where the Vd_{G-average} is an average of dispersion constants from lenses which have the highest dispersion constant in each lens group among the first to the third lens groups.

3. The system of claim 2, wherein the lens optical system further satisfies the following equation:
$$- 0.44 \leq \frac{{L}_{S}}{{L}_{f}} \leq - 0.32 ,$$
where the Lₛ is a difference between positions of the first lens in the second lens group in an optical axis direction for the case where the object distance is infinite and for the case where the object distance is an MOD, and the L_{f} is a position of the first lens in the second lens group for the case where the object distance is infinite.

4. The system of claim 3, wherein the lens optical system further satisfies the following equation:
$$0.54 \leq \frac{1}{{n}_{a}} \leq 0.63 ,$$
where the nₐ is a reciprocal of an average refractive index of all lenses used in the lens optical system.

5. The system of claim 4,
wherein the first lens facing the object side in the first lens group has a meniscus shape convex toward the object side, and the first lens facing the image side in the third lens group has a meniscus shape convex to the image side.

6. The system of claim 5,
wherein the second lens group includes at least one aspherical lens.

7. The system of claim 6,
wherein the first lens group or the third lens group includes at least one aspherical lens.

8. The system of claim 7,
wherein the first lens group or the third lens group includes at least one double-junction lens.
